(19) United States
(12) Patent Application Publication
(10) Pub. No.: US 2022/0317858 A1
(43) Pub. Date: Oct. 6, 2022

(54) GENERATING DIGITAL DRAWING CONTENT WITH HOLOGRAPHIC TOOLS

(71) Applicant: International Business Machines Corporation, Armonk, NY (US)

(72) Inventors: Venkata Vara Prasad Karri, Visakhapatnam (IN); Sarbajit K. Rakshit, Kolkata (IN)

(21) Appl. No.: 17/301,381

(22) Filed: Mar. 31, 2021

(51) Int. Cl. G06F 3/0481; G06F 3/01; H04N 9/31; G06F 3/0484; G03H 1/00

(52) U.S. Cl. CPC G06F 3/04815; G06F 3/016; H04N 9/3147; G06F 3/011; G06F 3/04845; G06F 3/017; G03H 1/0005

(57) ABSTRACT

A computer generates digital output by identifying, a digital display surface. The computer identifies a tool selected from a list of geometric shape drawing tools. The computer, in response to the tool identification, generates by a projector, a holographic model of the selected tool including interaction points into an interaction zone near the display surface. The computer receives a feed from a sensor associated with the interaction zone and identifies an interaction motion associated with an interaction point. The computer adjusts a model location, a model orientation, or a model size based on the interaction motion. The computer, in response to determining an interaction point is making virtual contact with the display surface, generates digital output on surface near the interaction point. The digital output corresponds, at least in part, to a predetermined shape associated with the selected tool.

### BACKGROUND

The present invention relates generally to the field of digital illustration, and more specifically, to producing digital content with interactive, computerized-generated tools.

Computerized illustration systems allow users to generate a wide range of digital content. In some cases, depending on the tools available, a system may facilitate the generation of documents that include predetermined shapes (arc, lines, angles, circles, and so forth) of various sizes and scales. For users who have previously learned to generate this kind of content with hand-held marking and measuring tools, these automated systems can increase the efficiency with which documents that use these shapes (e.g., technical drawings, blueprints, etc.) can be generated. While automated systems allow users to produce content, these systems tend to focus on generating output and provide limited guidance regarding geometric principles and relationships among shapes in the content. Unfortunately, in some cases, such as for users without insight regarding geometric principles that can be revealed by using shape generating tools (e.g., straight edges, compasses, protractors, etc.), use of some automated systems may reduce efficiency.

### SUMMARY

According to one embodiment, a computer-implemented method for generating digital output includes identifying, by a computer, a digital display surface. The computer identifies a tool selected from a list of geometric shape drawing tools. The computer, in response to the tool identification, generates by at least one projector, a holographic model of the selected tool including at least one interaction point into an interaction zone near the display surface. The computer receives a feed from a sensor associated with the interaction zone. The computer identifies from the feed a signal indicating an interaction motion associated with the at least one interaction point. The computer adjusts at least a model location, a model orientation, or a model size, in accordance, at least partially, with the interaction motion. The computer, in response to determining that an interaction point associated with the model is making virtual contact with the display surface, generating digital output on the surface at a marking location near the interaction point, with the digital output corresponding, at least in part, to a predetermined shape associated with the selected tool. According to aspects of the invention, the computer sends haptic feedback from a transducer to said at least one interaction point. According to aspects of the invention, the tool is selected from a list consisting of a straight edge, a compass, a protractor, a triangle, and a divider. According to aspects of the invention, the predetermined shape is line segment passing through reference points along an edge of said model when said selected tool is a straight edge; the predetermined shape is at least part of a circle having a radius based, at least in part on a distance between a compass model anchor point and said marking point when said selected tool is a compass; the predetermined shape is a representation of an angle formed by a model vertex marker and a plurality of model angle rays when said selected tool is a protractor; the predetermined shape is a representation of an angle formed by a plurality of line segments that pass through reference points along an edge of said model and that intersect at a reference corner of the tool when said selected tool is a triangle; and the predetermined shape is a line segment representing a distance between a divider model leg end and said marking point when said selected tool is a divider. According to aspects of the invention, when the tool is a divider, the model size is a distance between a first divider leg and a second divider leg; and when the tool is a compass, the model size is a distance between a first compass leg and a second compass leg. According to aspects of the invention, the computer identifies a group of tools, and the at least one projector generates a group of holographic models simultaneously. According to aspects of the invention, the digital output corresponds, at least in part, to a compound shape formed by a first shape and a second shape associated respectively with a first model and a second model of the group of tools.

In embodiments according to the present invention, system to generate digital output, which includes a computer system comprising a computer readable storage medium having program instructions embodied therewith, the program instructions executable by a computer to cause the computer to: identify a digital display surface; identify a tool selected from a list of geometric shape drawing tools; responsive to said tool identification, generating by at least one projector, a holographic model of the selected tool including at least one interaction point into an interaction zone proximate said display surface; receive a feed from a sensor associated with the interaction zone; identify from the feed a signal indicating an interaction motion associated with the at least one interaction point; adjust at least one of a model location, a model orientation, and a model size, in accordance, at least partially, with said interaction motion; responsive to determining that an interaction point associated with the model is making virtual contact with the display surface, generate digital output on said surface at a marking location proximate said interaction point, and wherein said digital output corresponds, at least in part, to a predetermined shape associated with the selected tool.

In another embodiment of the invention, a computer program product to generate digital output, the computer program product comprising a computer readable storage medium having program instructions embodied therewith, the program instructions executable by a computer to cause the computer to: identify, using the computer, a digital display surface; identify, using the computer, a tool selected from a list of geometric shape drawing tools; responsive to said tool identification, generating by at least one projector, a holographic model of the selected tool including at least one interaction point into an interaction zone proximate said display surface; receive, using the computer, a feed from a sensor associated with the interaction zone; identify, using the computer, from the feed a signal indicating an interaction motion associated with the at least one interaction point; adjust, using the computer, at least one of a model location, a model orientation, and a model size, in accordance, at least partially, with said interaction motion; responsive to determining that an interaction point associated with the model is making virtual contact with the display surface, generate digital output on said surface at a marking location proximate said interaction point, and wherein said digital output corresponds, at least in part, to a predetermined shape associated with the selected tool.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are set forth as below as:

FIG. 1 is a schematic block diagram illustrating an overview of a system for a method of generating digital content using holographic drawings tools according to embodiments of the present invention.

FIG. 2 is a flowchart illustrating a method, implemented using the system shown in FIG. 1, of generating digital content using holographic drawings tools according to aspects of the invention.

FIG. 3 is a schematic representation of an interaction zone according to aspects of the invention, a holographic straight edge tool projected into the interaction zone, associated sensors, and feedback generating elements implemented using the system shown in FIG. 1 of generating digital content using holographic drawings tools.

FIG. 4 is a schematic representation of aspects of output from a holographic straight edge tool implemented using the system shown in FIG. 1 of generating digital content using holographic drawings tools according to aspects of the invention.

FIG. 5A is a schematic representation of aspects of a holographic compass tool implemented using the system shown in FIG. 1 of generating digital content using holographic drawings tools according to aspects of the invention.

FIG. 5B is a schematic representation of adjusted aspects of the holographic compass tool shown in FIG. 5A.

FIG. 6 is a schematic representation of aspects of output from a holographic compass tool implemented using the system shown in FIG. 1 of generating digital content using holographic drawings tools according to aspects of the invention.

FIG. 7 is a schematic representation of aspects of a holographic protractor tool implemented using the system shown in FIG. 1 of generating digital content using holographic drawings tools according to aspects of the invention.

FIG. 8 is a schematic representation of aspects of output from a holographic protractor tool implemented using the system shown in FIG. 1 of generating digital content using holographic drawings tools according to aspects of the invention.

FIG. 9 is a schematic representation of aspects of a holographic protractor tool used with a holographic straight edge tool implemented using the system shown in FIG. 1 of generating digital content using holographic drawings tools according to aspects of the invention.

FIG. 10 is a schematic representation of modified aspects of output shown in FIG. 8, including output from a holographic protractor tool used with a holographic straight edge tool implemented using the system shown in FIG. 1 of generating digital content using holographic drawings tools according to aspects of the invention.

FIG. 11 is a schematic representation of aspects of a holographic protractor tool used with a physical straight edge tool implemented using the system shown in FIG. 1 of generating digital content using holographic drawings tools according to aspects of the invention.

FIG. 12 is a schematic representation of modified aspects of output shown in FIG. 10, including output from a holographic protractor tool used with a holographic straight edge tool and a physical straight edge tool implemented using the system shown in FIG. 1 of generating digital content using holographic drawings tools according to aspects of the invention.

FIG. 13 is a schematic representation of aspects of a holographic triangle tool implemented using the system shown in FIG. 1 of generating digital content using holographic drawings tools according to aspects of the invention.

FIG. 14 is a schematic representation of aspects of output from a holographic triangle tool implemented using the system shown in FIG. 1 of generating digital content using holographic drawings tools according to aspects of the invention.

FIG. 15 is a schematic representation of aspects of a holographic triangle tool implemented using the system shown in FIG. 1 of generating digital content using holographic drawings tools according to aspects of the invention.

FIG. 16 is a schematic representation of aspects of output from a holographic triangle tool implemented using the system shown in FIG. 1 of generating digital content using holographic drawings tools according to aspects of the invention.

FIG. 17 is a schematic block diagram depicting a computer system according to an embodiment of the disclosure which may be incorporated, all or in part, in one or more computers or devices shown in FIG. 1, and cooperates with the systems and methods shown in FIG. 1.

FIG. 18 depicts a cloud computing environment according to an embodiment of the present invention.

FIG. 19 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a participant” includes reference to one or more of such participants unless the context clearly dictates otherwise.

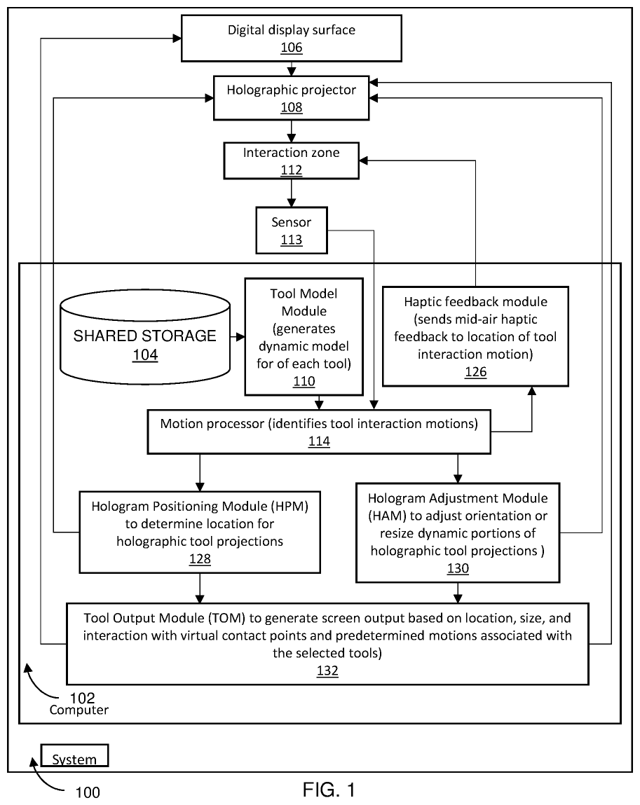

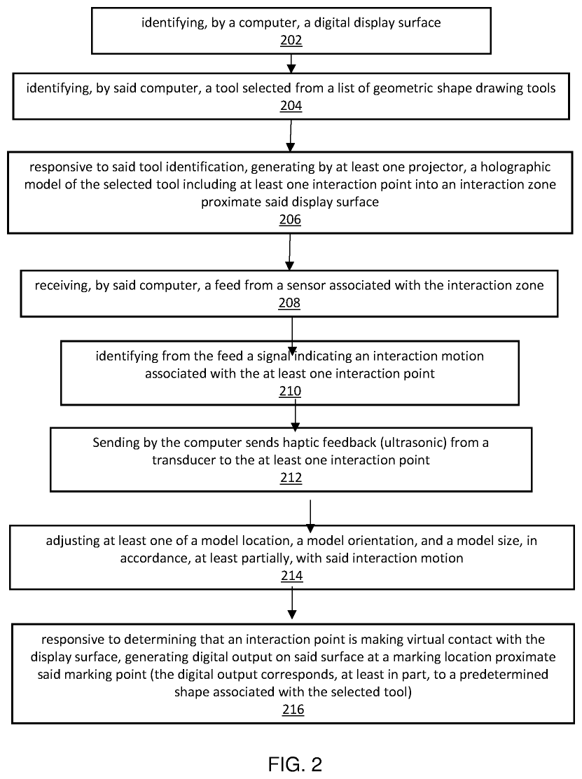

Now with combined reference to the Figures generally and with particular reference to FIG. 1 and FIG. 2, an overview of a method for generating digital content using holographic drawings tools usable within a system 100 as carried out by a server computer 102 having optionally shared storage 104 is provided. The server computer 102 is in operative communication with a digital display surface 106 onto which digital content is generated. According to aspects of the invention, the digital display surface 106 is a video screen associated with a tablet, phone, or other similar device capable of displaying digital media content. The server computer 102 is in operative communication with one or more holographic projectors 108 that, in cooperation with a Tool Model Module (TMM) 110, generates 3D holographic (e.g., light-based) representations of geometric shape drawing tools. According to aspects of the invention, the holographic models, as will be described more fully below, represent tools selected from a preselected list of tools suited for generating known geometric shapes (e.g., as used in Euclidean geometry).

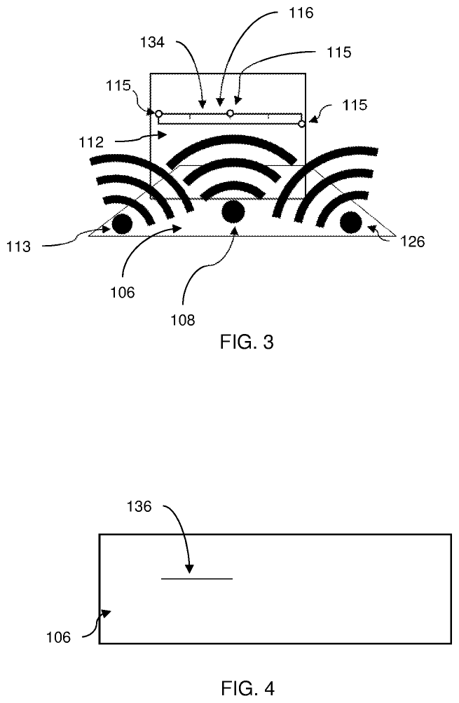

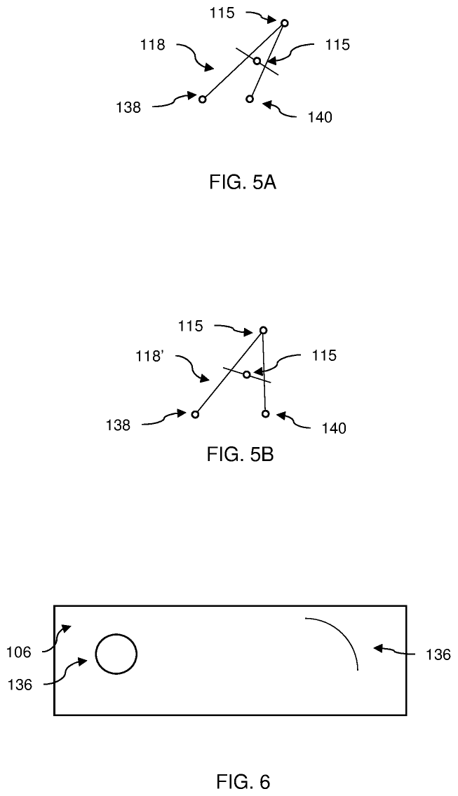

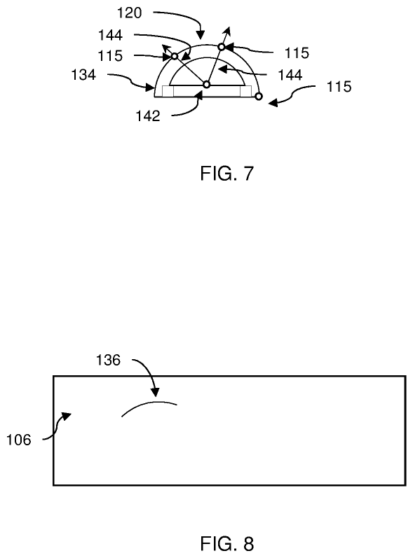

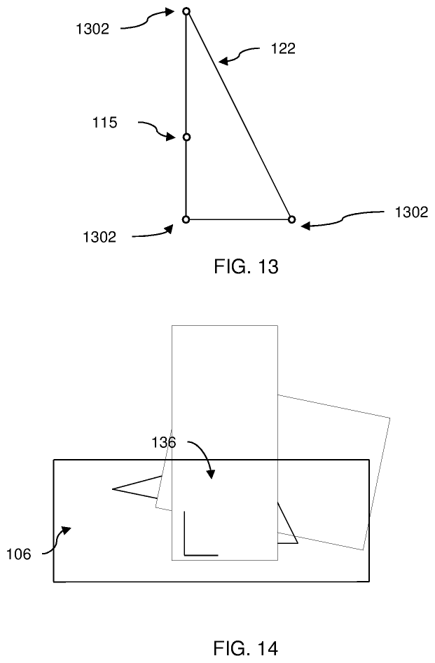

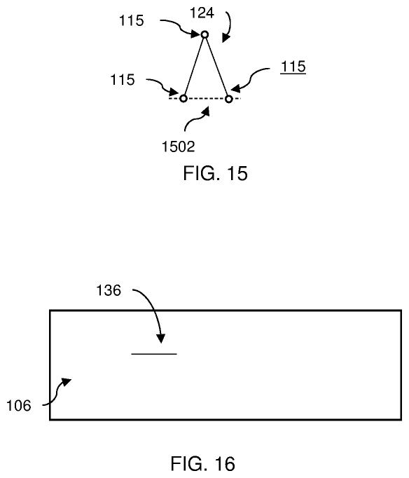

The TMM 110 has dynamic, three-dimensional mapping data for tools to be modeled by aspects of the present system 100. As will be discussed more fully below, the projected tool model is selected from a list of models including those for a straight edge 116 (e.g., as seen in FIG. 3), a compass 118 adjusted to select a first radius (e.g., as seen in FIG. 5A), a compass 118′ adjusted to select a second radius (e.g., as seen in FIG. 5B), a protractor 120 (e.g., as seen in FIG. 7), a triangle 122 (e.g., as seen in FIG. 13), and a divider 124 (e.g., as seen in FIG. 15). It is noted that holographic models of other tools may also be provided and selected in accordance with the judgment of one skilled in this field. According to aspects of the invention, the tool selection is based on the content generation goals of a user, with different tools being selected to allow generation of predetermined shapes as needed. According to aspects of the invention, a straight edge tool hologram 116 is selected to facilitate generation of line segments passing through to or more reference points. According to aspects of the invention, a compass tool hologram is selected to facilitate generation of arcs and other portions of circles having a radii selected via model size adjustment by a user. According to aspects of the invention, a protractor tool hologram is selected to facilitate generation, and measurement of, angles formed by a model vertex marker and two or more angle rays. According to aspects of the invention, a divider tool hologram is selected to adjustably measure and transfer distances between two points (e.g., as demarked by a line segment selected by a user). According to aspects of the invention, a triangle tool hologram is selected to generate angles formed by line segments with triangle edges and that intersect at a tool reference corner (e.g., a triangle vertex). It is noted that the tools modelled by aspects of the invention are sometimes referred to as Euclidean geometry construction tools, and the model holograms generated will represent the physical forms of the tools known by those familiar with these tools. It is noted that the hologram models will facilitate dynamic articulation as appropriate to simulate interaction with physical versions of the tools represented.

According to aspects of the invention, the hologram projector 108 projects a light-based model (e.g., a hologram) of the selected tool into an interaction zone 112 near (e.g., on or slightly above) the digital display surface 106. In an embodiment, the interaction zone 112 is a 3-dimensional space that extends generally away (e.g., several inches to several feet, depending on the judgement of one skilled in this field) and which has a cross sectional dimension that is substantially coextensive with the digital display surface 106.

According to aspects of the invention, the system 100 may include several holographic projectors (e.g., collected into an array) installed on the display surface 106, and the projectors are dynamically selected as needed to project a 3-dimensional hologram of one or more of the tool models available for selection.

The server computer 102 communicates with a sensor 113 (e.g., a camera, ultrasonic scanner, or other motion detection component selected by one skilled in this field) that monitors activity in the interaction zone 112. During operation, the sensor 113 sends a feed signal associated with motion occurring in the interaction zone 112 to a motion processor 114 for assessment. The motion processor 114 identifies virtual interaction of a user (not shown) with one or more projected model 116, 118, 120, 122, 124 projected into the interaction zone 112. According to aspects of the invention, the motion processor 114 is especially suited to identify user hand movements that indicate a desire to locate the projected model at a target location in the interaction zone, to change an orientation (e.g., to rotate about an axis) of the projected tool, and to adjust a dynamic element of the model (e.g., to resize the space between compass model legs to select a radius, to a change the distance between divider legs to mark a selected distance, etc.). According to aspects of the invention, the motion processor 114 is adapted to identify detect user hand motions within the interaction zone that coincide with virtual interaction points 115 associated with the projected models to indicate how a user wishes to interact with the model.

The server computer 102 includes Haptic Feedback Module (HFM) 126 that directs mid-air haptic feedback to locations which, as indicated by motion processor 114, correspond to virtual interaction points on the projected model. In particular, HFM 126 includes one or several (e.g., arranged in an array) ultrasonic transducers adapted and positioned to create midair haptic effects at strategically selected locations (e.g., such as positions in the interaction zone 112 that physically correspond to locations associated with virtual contact between a user hand and strategically located interaction points 115 associated with the projected model). The virtual contact can be captured directly the sensor 113 (e.g., with optical indication of virtual hand contact with a model interaction point), by sensing that a user finger or hand position currently matches the mapped location of a holographic tool interaction point, or by some other known technique selected by one skilled in this field. According to aspects of the invention, the haptic feedback directed by HFM 126 coincides temporally and location-wise with virtual tool interaction point contact to simulate physical interaction with the holographic tool projection.

According to aspects of the invention, the motion processor 114 tracks and categorizes the motion of objects (such as a user hand, one or more user fingers, a stylus or other physical pointing items, etc.) within the interaction zone 112. When the motion processor 114 identifies a hand swipe motion (or other pre-established gesture recognized by the motion processor as intended to indicate a desire to move a projected tool), the Hologram Positioning Module (HPM) 128 recalculates appropriate mapping coordinates for the tool projected at the indicated location. The HPM 128 passes the revised coordinates to the projector 108 generating the tool projection to be relocated, and the location of the projected tool hologram is adjusted accordingly. When the motion processor 114 identifies a hand twisting motion (or other pre-established gesture recognized by the motion processor as intended to indicate a desire to place a projected tool into a particular orientation), the Hologram Adjustment Module (HAM) 130 recalculates appropriate mapping coordinates for the tool projection with the indicated orientation. The HAM 130 passes the revised coordinates to the projector 108 generating the targeted tool projection, and the orientation of the projected tool hologram is adjusted accordingly. When the motion processor 114 identifies a finger twisting motion (or other pre-established gesture recognized by the motion processor as intended to indicate a desire to adjust movable portions (e.g., the compass radius indicated by the spacing between a compass support leg and a compass marking leg, the span between divider leg ends, etc.) of a projected tool, the Hologram Adjustment Module (HAM) 130 recalculates appropriate mapping coordinates for the tool projection with the indicated adjustment. The HAM 130 passes the revised coordinates to the projector 108 generating the targeted tool projection, and the size or position of the intended tool hologram is adjusted accordingly.

The server computer 102 includes a Tool Output Module 132 that generates digital output on, within, or otherwise associated with the digital display surface 106 in accordance with the location, orientation, and size of a selected tool. According to aspects of the invention, the TOM 132 determines when and where output should be generated, and the digital display and the server computer 102 updates the display surface 106 accordingly.

In an embodiment, the TOM 132 has information about virtual surface contact points associated with each of the tool holograms. According to aspects of the invention, the TOM 132 indicates that digital output should be generated along a tool edge when an extended finger or stylus is moved along an edge of a virtual tool (e.g., as cooperatively captured by the sensor 113 and identified by the motion processor 114), when a projected tool edge 134 is determined to be making virtual contact with the digital display surface 106. It is noted that content generation may also be indicated by other gestures recognized by the TOM 132, as established by one skilled in this field.

According to aspects of the invention, a tool model may include one or more marking elements (e.g., a virtual pencil tip associated with a compass, etc.), and the TOM 132 generates digital content representing direct virtual contact between those marking elements and the display surface 106. According to aspects of the invention, the TOM 132 generates digital output based on predetermined virtual tool location, size, and interaction with virtual contact points and predetermined motions associated with the selected tools. In an embodiment, the TOM 132 has information about preselected output generating paths associated with the tools being represented by hologram, and the output generated by the TOM is based on that information. For example, according to aspects of the invention, the TOM 132 will generate line segments aligned with virtual tool edges, when a straight edge model 116 is selected. According to aspects of the invention, the TOM 132 will generate arcs having a virtually determined radius, when a compass model 118 is selected. According to aspects of the invention, the TOM 132 will generate angle measurements and representations of angle elements, when a protractor model 120 is selected. According to aspects of the invention, the TOM 132 will generate representations of predetermined angles corresponding to virtual triangle elements and edges, when a triangle model 122 is selected. According to aspects of the invention, the TOM 132 will generate marks indicating line segment (or other span), measurements when a divider model 124 is selected. It is noted that the TOM 132 may also generate free form output if a simple pointing element is guided along the display surface. It is also noted that the TOM 132 may generate content that represents interaction between more than one virtual tool and between a virtual tool and a physical tool.

Now with specific reference to FIG. 2, and to other figures generally, a method of generating digital content using holographic drawings tools according to aspects of the invention will be described. The server computer 102, at block 202 identifies a digital display surface. As noted above, the surface may be a display screen associated with a tablet, phone, or other similar device capable of displaying digital media content.

The server computer 102 at block 204 identifies a tool selected from a list of geometric shape drawing tools. According to aspects of the invention, tool selection is based, at least in part, on the desired content goals of a user. According to aspects of the invention, a straight edge tool hologram 116 is selected to facilitate generation of line segments passing through to or more reference points. According to aspects of the invention, a compass tool hologram 118 is selected to facilitate generation of arcs and other portions of circles having a radii selected via model size adjustment by a user. According to aspects of the invention, a protractor tool hologram 120 is selected to facilitate generation, and measurement of, angles formed by a model vertex marker and two or more angle rays. According to aspects of the invention, a triangle tool hologram 122 is selected to generate angles formed by line segments with triangle edges that intersect at a tool reference corner (e.g., a triangle vertex). According to aspects of the invention, a divider tool hologram 124 is selected to adjustably measure and transfer distances between two points (e.g., as demarked by a line segment selected by a user).

The server computer 102 generates, via Tool Model Module 110 at block 206, responsive to the tool identification by at least one projector, a holographic model of the selected tool including at least one interaction point 115 into an interaction zone 112 proximate said display surface 106. According to aspects of the invention, projectors may be installed on, below the display surface, or otherwise near the display surface 106, and the projectors are dynamically selected as needed to project selected tools at user indicated locations within the interaction zone 112. In an embodiment, the projectors 108 are controlled by software or application programming interface API elements incorporated with, or otherwise available to, the server computer 102.

The server computer 102 at block 208 receives a feed from sensor 113 associated with the interaction zone 112. During operation, when a user interacts with the virtual tool hologram interaction points 115, the sensor 113 tracks user interaction motion.

The server computer 102, via motion processor 114 at block 210, identifies from the feed a signal indicating one or more preidentified interaction motions associated with the interaction points 115. According to aspects of the invention, the motion processor 114 interprets and categorizes user interaction with model interaction points 115 and determines whether adjustments to the projected model is appropriate.

The server computer 102, via haptic feedback module 126 sends mid-air haptic feedback to an virtual interaction point strategically selected to coincide with the presence of an interaction element (e.g., user hand, finger, stylus, etc.) to simulate physical contact with the virtual tool at the interaction point. According to aspects of the invention, the haptic feedback is an ultrasonic signal from one or more transducers adapted to send adjustable signals to interaction points 115 throughout the interaction zone. According to aspects of the invention, different signals may be sent to confirm or simulate different types of tool interaction.

The server computer 102 at block 214 adjusts one or more attribute of the tool hologram. In particular, as noted above, when the motion processor 114 identifies a hand swipe motion (or other pre-established gesture recognized by the motion processor as intended to indicate a desire to move a projected tool), the Hologram Positioning Module (HPM) 128 recalculates appropriate mapping coordinates for the tool projected at the indicated location. The HPM 128 passes the revised coordinates to the projector 108 generating the tool projection to be relocated, and the location of the projected tool hologram is adjusted accordingly. When the motion processor 114 identifies a hand twisting motion (or other pre-established gesture recognized by the motion processor as intended to indicate a desire to place a projected tool into a particular orientation), the Hologram Adjustment Module (HAM) 130 recalculates appropriate mapping coordinates for the tool projection with the indicated orientation. The HAM 130 passes the revised coordinates to the projector 108 generating the targeted tool projection, and the orientation of the projected tool hologram is adjusted accordingly. When the motion processor 114 identifies a finger twisting motion (or other pre-established gesture recognized by the motion processor as intended to indicate a desire to adjust movable portions (e.g., the compass radius indicated by the spacing between a compass support leg and a compass marking leg, the span between divider leg ends, etc.) of a projected tool, the Hologram Adjustment Module (HAM) 130 recalculates appropriate mapping coordinates for the tool projection with the indicated adjustment. The HAM 130 passes the revised coordinates to the projector 108 generating the targeted tool projection, and the size or position of the intended tool hologram is adjusted accordingly.

The server computer 102 via Tool Output Module 132 at block 216, in response to determining that an interaction point 115 is making virtual contact with the display surface 106, generates digital output 136 on the surface at a marking location proximate the interaction point. According to aspects of the invention, the digital output corresponds, at least in part, to a predetermined shape associated with the selected tool.

Now with reference to FIG. 3 and FIG.4, aspects of a straight edge tool hologram and associated digital content output 136 generated by use will described. The straight edge tool hologram 116 includes several (e.g., four) straight edges 134 and resembles a rectangle. During use, digital output 136 represents a line segment having passed through one or more interaction points 115 associated with the tool edges.

Now with reference to FIG. 5A, FIG. 5B, and FIG. 6, aspects of an adjusted compass tool hologram 118, 118′ and associated digital content output 136 generated by use will described. The compass models 118, 118′ in FIG. 5A and FIG. 5B include a marking point 138 at the end of a virtual marking leg and an anchor point 140 at the end of virtual anchor leg. The compass models 118,118′ each include interaction points 115, and virtual interaction (e.g., spinning) of the middle interaction point will adjust the radius for digital arc output generated by the tool. FIG. 5B shows a radius larger than the model shown in FIG. 5A. Output from both compass models 118, 118′ is shown in FIG. 6.

Now with reference to FIG. 7 and FIG. 8, aspects of a protractor tool hologram 120, and associated digital content output 136 generated by use will described. The protractor tool hologram 120 represents a standard protractor tool and includes tool edges 134 and interaction points 115. An interaction point near the bottom of the tool is considered a vertex point 142, and this is especially suited for using the tool to mark and measure angles. According to aspects of the invention, the angles are bounded by angle rays 144. One form of digital output 136 from using this tool resembles an arc, as shown in FIG. 8.

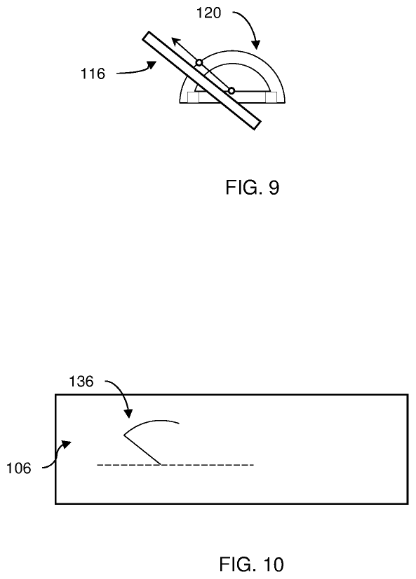

Now with reference to FIG. 9 and FIG. 10, aspects of a protractor tool hologram 120, and associated digital content output 136 generated by use will described. In FIG. 9, a protractor tool model 120 and a straight edge tool model 116 are shown in use together. Output 136 from this combined tool use is shown in FIG. 10, where an arc and a line segment passing through an angle vertex are included.

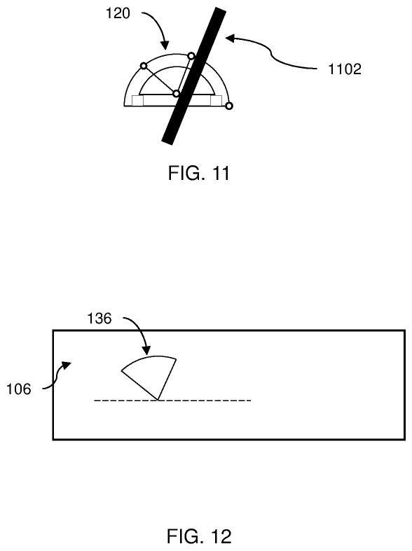

Now with reference to FIG. 11 and FIG. 12, aspects of a protractor tool hologram 120, and associated digital content output 136 generated by use will described. In FIG. 11, a protractor tool model 120 and a physical straight edge 1102 are shown in use together. Output 136 from this combined tool use is shown in FIG. 12, where an arc and two line segments intersecting at an angle vertex are included. One of the line segments was formed with virtual straight edge model 116 (e.g., in FIG. 9 and FIG. 10) and the second line segment was formed with physical straight edge 1102 in FIG. 11.

Now with reference to FIG. 13 and FIG. 14, aspects of a triangle tool hologram 122 and associated digital content output 136 generated by use will be described. The triangle tool hologram 116 includes several (e.g., three) straight edges 134 and several (e.g., three) corners 1302 or vertices and at least one interaction point 115. During use, digital output 136 represents pairs of line segments that intersect at one of the corners 1302.

Now with reference to FIG. 15, FIG. 16, aspects of a divider tool hologram 124 and associated digital content output 136 generated by use will described. The divider model 124 includes interaction points 115, and virtual interaction (e.g., spreading) of distal end interaction points will adjust the span measured by the tool. Output from this model 124 (e.g., a measured span 1502) is shown in FIG. 16.

Regarding the flowcharts and block diagrams, the flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

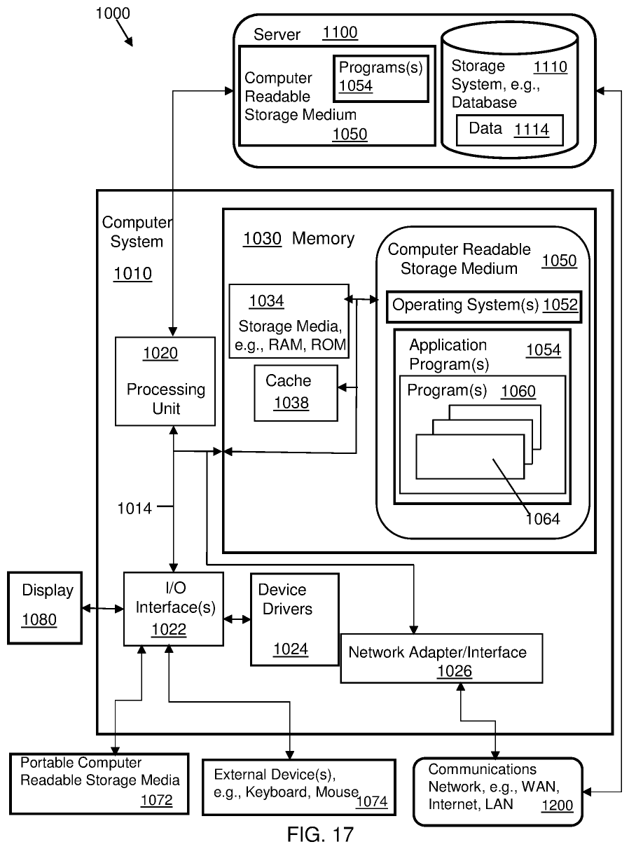

Referring to FIG. 17, a system or computer environment 1000 includes a computer diagram 1010 shown in the form of a generic computing device. The method of the invention, for example, may be embodied in a program 1060, including program instructions, embodied on a computer readable storage device, or computer readable storage medium, for example, generally referred to as memory 1030 and more specifically, computer readable storage medium 1050. Such memory and/or computer readable storage media includes non-volatile memory or non-volatile storage. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure.

One or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

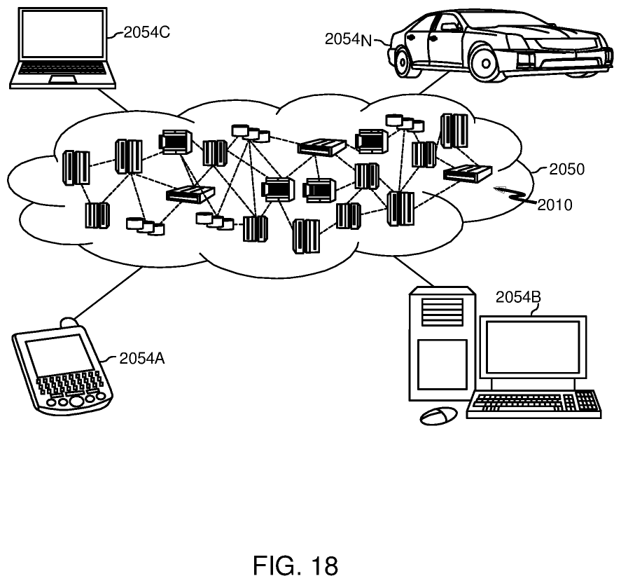

Referring now to FIG. 18, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 18 are intended to be illustrative only and that computing nodes 2010 and cloud computing environment 2050 can communicate with any type of computerized device over any type of network and/or network addressable connection (e.g., using a web browser).

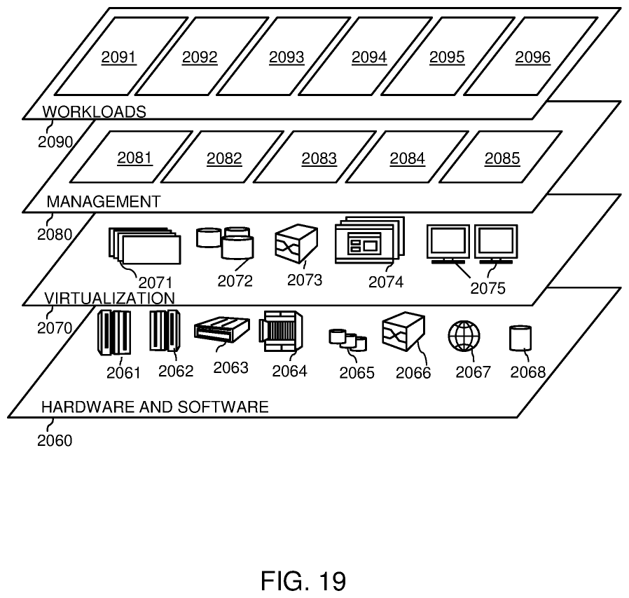

Referring now to FIG. 19, a set of functional abstraction layers provided by cloud computing environment 2050 (FIG. 18) is shown. It should be understood in advance that the components, layers, and functions shown in FIG. 19 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and generating digital drawing content with holographic tools 2096.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer implemented method of generating digital output, comprising:
identifying, by a computer, a digital display surface;
identifying, by said computer, a tool selected from a list of geometric shape drawing tools;
responsive to said tool identification, generating by at least one projector, a holographic model of the selected tool including at least one interaction point into an interaction zone proximate said display surface;
receiving, by said computer, a feed from a sensor associated with the interaction zone;
identifying from the feed a signal indicating an interaction motion associated with the at least one interaction point;
adjusting at least one of a model location, a model orientation, and a model size, in accordance, at least partially, with said interaction motion;
responsive to determining that an interaction point associated with the model is making virtual contact with the display surface, generating digital output on said surface at a marking location proximate said interaction point,
wherein said digital output corresponds, at least in part, to a predetermined shape associated with the selected tool;
using, by the computer, a combined tool of a protractor tool model and a physical straight edge together; and
generating output from this combined tool including an arc and two line segments intersecting at an angle vertex.

2. The method of claim 1, wherein said computer sends haptic feedback from a transducer to said at least one interaction point.

3. The method of claim 1, wherein said tool is selected from a group consisting of a straight edge, a compass, a protractor, a triangle, and a divider.

4. The method of claim 3, wherein:
said predetermined shape is “a line segment passing through reference points along an edge of said model when said selected tool is a straight edge;
wherein said predetermined shape is at least part of a circle having a radius based, at least in part on a distance between a compass model anchor point and said marking point when said selected tool is a compass;
wherein said predetermined shape is a representation of an angle formed by a model vertex marker and a plurality of model angle rays when said selected tool is a protractor;
wherein said predetermined shape is a representation of an angle formed by a plurality of line segments that pass through reference points along an edge of said model and that intersect at a reference corner of the tool when said selected tool is a triangle; and
wherein said predetermined shape is a line segment representing a distance between a divider model leg end and said marking point when said selected tool is a divider.

5. The method of claim 4, wherein:
when said tool is a divider, the model size is a distance between a first divider leg and a second divider leg; and
wherein when said tool is a compass, the model size is a distance between a first compass leg and a second compass leg.

6. The method of claim 1, wherein said computer identifies a plurality of tools, and wherein the at least one projector generates a plurality of holographic models simultaneously.

7. The method of claim 6, wherein said digital output corresponds, at least in part, to a compound shape formed by a first shape and a second shape associated respectively with a first model and a second model of said plurality of tools.

8. A system to generate digital output, which comprises:
a computer system comprising a computer readable storage medium having program instructions embodied therewith, the program instructions executable by a computer to cause the computer to:
identify a digital display surface;
identify a tool selected from a list of geometric shape drawing tools;
responsive to said tool identification, generating by at least one projector, a holographic model of the selected tool including at least one interaction point into an interaction zone proximate said display surface;
receive a feed from a sensor associated with the interaction zone;
identify from the feed a signal indicating an interaction motion associated with the at least one interaction point;
adjust at least one of a model location, a model orientation, and a model size, in accordance, at least partially, with said interaction motion;
responsive to determining that an interaction point associated with the model is making virtual contact with the display surface, generate digital output on said surface at a marking location proximate said interaction point,
wherein said digital output corresponds, at least in part, to a predetermined shape associated with the selected tool;
using, by the computer, a combined tool of a protractor tool model and a physical straight edge together; and
generate output from this combined tool including an arc and two line segments intersecting at an angle vertex.

9. The system of claim 8, wherein said computer sends haptic feedback from a transducer to said at least one interaction point.

10. The system of claim 8, wherein said tool is selected from a group consisting of a straight edge, a compass, a protractor, a triangle, and a divider.

11. The system of claim 10, wherein:
said predetermined shape is a line segment passing through reference points along an edge of said model when said selected tool is a straight edge;
wherein said predetermined shape is at least part of a circle having a radius based, at least in part on a distance between a compass model anchor point and said marking point when said selected tool is a compass;
wherein said predetermined shape is a representation of an angle formed by a model vertex marker and a plurality of model angle rays when said selected tool is a protractor;
wherein said predetermined shape is a representation of an angle formed by a plurality of line segments that pass through reference points along an edge of said model and that intersect at a reference corner of the tool when said selected tool is a triangle; and
wherein said predetermined shape is a line segment representing a distance between a divider model leg end and said marking point when said selected tool is a divider.

12. The system of claim 11, wherein:
when said tool is a divider, the model size is a distance between a first divider leg and a second divider leg; and
wherein when said tool is a compass, the model size is a distance between a first compass leg and a second compass leg.

13. The system of claim 8, wherein said computer identifies a plurality of tools, and wherein the at least one projector generates a plurality of holographic models simultaneously.

14. The system of claim 13, wherein said digital output corresponds, at least in part, to a compound shape formed by a first shape and a second shape associated respectively with a first model and a second model of said plurality of tools.

15. A computer program product to generate digital output, the computer program product comprising a computer readable storage medium having program instructions embodied therewith, the program instructions executable by a computer to cause the computer to:
identify, using the computer, a digital display surface;
identify, using the computer, a tool selected from a list of geometric shape drawing tools;
responsive to said tool identification, generating by at least one projector, a holographic model of the selected tool including at least one interaction point into an interaction zone proximate said display surface;
receive, using the computer, a feed from a sensor associated with the interaction zone;
identify, using the computer, from the feed a signal indicating an interaction motion associated with the at least one interaction point;
adjust, using the computer, at least one of a model location, a model orientation, and a model size, in accordance, at least partially, with said interaction motion;
responsive to determining that an interaction point associated with the model is making virtual contact with the display surface, generate digital output on said surface at a marking location proximate said interaction point,
wherein said digital output corresponds, at least in part, to a predetermined shape associated with the selected tool;
using, by the computer, a combined tool of a protractor tool model and a physical straight edge together; and
generate output from this combined tool including an arc and two line segments intersecting at an angle vertex.

16. The computer program product of claim 15, wherein said computer sends haptic feedback from a transducer to said at least one interaction point.

17. The computer program product of claim 15, wherein said tool is selected from a group consisting of a straight edge, a compass, a protractor, a triangle, and a divider.

18. The computer program product of claim 17, wherein:
said predetermined shape is a line segment passing through reference points along an edge of said model when said selected tool is a straight edge;
wherein said predetermined shape is at least part of a circle having a radius based, at least in part on a distance between a compass model anchor point and said marking point when said selected tool is a compass;
wherein said predetermined shape is a representation of an angle formed by a model vertex marker and a plurality of model angle rays when said selected tool is a protractor;
wherein said predetermined shape is a representation of an angle formed by a plurality of line segments that pass through reference points along an edge of said model and that intersect at a reference corner of the tool when said selected tool is a triangle; and
wherein said predetermined shape is a line segment representing a distance between a divider model leg end and said marking point when said selected tool is a divider.

19. The computer program product of claim 15, wherein said computer identifies a plurality of tools, and wherein the at least one projector generates a plurality of holographic models simultaneously.

20. The computer program product of claim 19, wherein said digital output corresponds, at least in part, to a compound shape formed by a first shape and a second shape associated respectively with a first model and a second model of said plurality of tools.
